(19) United States
(12) Patent Application Publication
(10) Pub. No.: US 2017/0058096 A1
(43) Pub. Date: Mar. 2, 2017

(54) METHODS OF MAKING EPOXY COMPOSITES BASED ON FLY ASH CARBON NANOTUBES

(71) Applicant: King Abdulaziz University, Jeddah (SA)

(72) Inventors: Numan SALAH, Jeddah (SA); Sami S. HABIB, Jeddah (SA); Zishan H. KHAN, Jeddah (SA); Mahmoud N. NAHAS, Jeddah (SA)

(73) Assignee: King Abdulaziz University, Jeddah (SA)

(21) Appl. No.: 14/843,690

(22) Filed: Sep. 2, 2015

(51) Int. Cl. C08K 3/04

(52) U.S. Cl. CPC C08K 3/04; C08K 2003/045

(57) ABSTRACT

A method for making an epoxy-carbon nanotube polymer composite. Carbon nanotubes of fly ash are initially dispersed in an organic solvent, then an epoxy resin is added to the dispersion. The epoxy-carbon nanotube mixture is ultrasonicated, degassed, mixed with a curative, then placed into a mold to cure to form the composite. The composite produced contains different amounts of fly ash carbon nanotubes homogeneously dispersed an epoxy resin matrix, and exhibits unusual physical properties such as viscoelasticity and flexibility.

### BACKGROUND OF THE INVENTION

Technical Field

The present invention relates to polymer composites. More specifically, the present invention relates to methods of making an epoxy polymer composite containing fly ash carbon nanotubes.

Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Epoxy resin is one of the most common polymer matrices used in advanced composite materials. Over the years, many attempts have been made to modify epoxy by adding different fillers to improve the matrix-dominated composite properties. In recent years, nano-scaled materials have been considered as filler material for epoxy to produce high performance nanocomposites with enhanced properties [G. Zhang, Z. Rasheva, J. Karger-Kocsis, and T. Burkhart, Express Polymer Letters 5, 859 (2011); G. J. Xian, R. Walter, and F. Haupert, Composites Science and Technology 66, 3199 (2006); A. Martone, C. Formicola, F. Piscitelli, M. Lavorgna, M. Zarrelli, V. Antonucci, and M. Giordano, Express Polymer Letters 6, 520 (2012); Lan-Hui Sun, Zoubeida Ounaies, Xin-Lin Gao, Casey A. Whalen, and Zhen-Guo Yang, Journal of Nanomaterials 2011, 307589 (2011); P. Karapappas, P. Tsotra, and K. Scobbie, Express Polymer Letters 5, 218 (2011)—each incorporated herein by reference in its entirety].

Fly ash is a by-product from the use of coal or heavy/crude oil as a fuel mainly in power plants. The ash is often considered as a hazardous waste that poses serious environmental issues. Several studies have proposed ways to utilize fly ash, thereby decreasing waste in landfills, which could avoid serious environmental challenges [J. Li, X. Zhuang, O. Font, N. Moreno, V. R. Vallejo, X. Querol, A. Tobias, J. Hazard. Mater. 265, 242 (2014); S. S. Habib, Int. J. Nano. Biomaterials 2, 437 (2009); V. L. Markad, K. M. Kodam, V. S. Ghole, J. Hazard. Mater. 215-216, 191 (2012); G. R. Qian, J. Shi, Y. L. Cao, Y. F. Xu, P. C. Chui, J. Hazard. Mater. 152, 196 (2008)—each incorporated herein by reference in its entirety]. Recently, Salah et al. have released the catalysts present in the fly ash and used them to grow carbon nanotubes (CNTs). Salah et al. also reported on the production of CNTs by using ultrasonicated carbon rich fly ash as both a precursor and a catalyst [N. Salah, S. S. Habib, Z. H. Khan, A. Memic, M. N. Nahas, Digest J. Nanomater.

Biostruc. 7, 1279 (2012); N. A. Salah. Method of forming carbon nanotubes from carbon-rich fly ash. U.S. Pat. No. 8,609,189—each incorporated herein by reference in its entirety]. This method seems to be a promising choice for mass production of CNTs at a very low cost. It also offers a solution for reducing the land filled fly ash.

Polymer- and CNT-based nanocomposites have attracted great interest because they include superior mechanical properties [A. Martone, C. Formicola, F. Piscitelli, M. Lavorgna, M. Zarrelli, V. Antonucci, and M. Giordano, Express Polymer Letters 6, 520 (2012); Lan-Hui Sun, Zoubeida Ounaies, Xin-Lin Gao, Casey A. Whalen, and Zhen-Guo Yang, Journal of Nanomaterials 2011, 307589 (2011)—each incorporated herein by reference in its entirety]. Different polymer/CNTs nanocomposites have been synthesized by incorporating CNTs into various polymer matrices, such as polyamides, polyimides, epoxy, polyurethane and polypropylene [C. G. Zhao, G. J. Hu, R. Justice, D. W. Schaefer, S. Zhang, M. S. Yang, C. C. Han, Polymer, 46, 5125 (2005); S. Kim, T. W. Pechar, and E. Marand, Desalination, 192, 330 (2006); H. Cai, F. Y. Yan, and Q. J. Xue, Materials Science and Engineering: A, 364, 4 (2004); F. H. Gojny, M. H. G. Wichmann, B. Fiedler, and K. Schulte, Composites Science and Technology, 65, 2300 (2005); H. C. Kuan, C. M. Ma, W. P. Chang, S. M. Yuen, H. H. Wu, and T. M. Lee, Composites Science and Technology, 65, 1703 (2005); A. Szentes, C. Varga, G. Horvath, L. Bartha, Z. Kony, H. Haspel, J. Szel, A. Kukovecz, Express Polymer Letters, 6, 494 (2012)—each incorporated herein by reference in its entirety].

As the myriad of uses for epoxy continues to expand and variants of epoxy are constantly being developed, the present disclosure aims to provide a method for fabricating an epoxy-CNT nanocomposite that leads to the nanocomposite product having properties such as high resistance to applied strain as reflected by elongation-at-break values.

### BRIEF SUMMARY OF THE INVENTION

The present disclosure is directed to a method for preparing an epoxy-fly ash carbon nanotube polymer composite. In the method, fly ash carbon nanotubes are dispersed in a non-aqueous solvent to form a fly ash carbon nanotube dispersion. An epoxy resin is mixed with the fly ash carbon nanotube dispersion to form an epoxy resin-fly ash carbon nanotube mixture. The epoxy resin-fly ash carbon nanotube mixture is sonicated to form a homogeneous epoxy resin-fly ash carbon nanotube mixture. Then, the homogeneous epoxy resin-fly ash carbon nanotube mixture is degassed, then a hardening agent is mixed with the homogeneous epoxy resin-fly ash carbon nanotube mixture. The fly ash epoxy resin-carbon nanotube mixture is cured in a mold to form the epoxy-fly ash carbon nanotube polymer composite.

In one or more embodiments, the fly ash carbon nanotubes are derived from heavy fuel oil fly ash having a carbon content of 80% and higher.

In some embodiments, the fly ash carbon nanotubes are multi-walled and have an outer diameter of 0.5-10 nm.

In some embodiments, the fly ash carbon nanotube dispersion has a fly ash carbon nanotube concentration of 20-250 g/L.

In certain embodiments, the organic solvent is polar and can be methanol, ethanol, isopropanol, n-propanol, n-butanol, acetone, dimethylformamide, dimethylacetamide, acetonitrile, tetrahydrofuran, ethyl acetate, nitromethane, propylene carbonate or dimethyl sulfoxide.

In one embodiment, the epoxy resin-fly ash carbon nanotube mixture has an epoxy resin/fly ash carbon nanotube weight ratio of 10-1000:1.

In certain embodiments, the epoxy resin-fly ash carbon nanotube mixture is sonicated at 100 W, 42 kHz for 3-6 h.

In one embodiment, the sonicating removes the organic solvent from the epoxy resin-fly ash carbon nanotube mixture.

In some embodiments, the homogeneous epoxy resin-fly ash carbon nanotube mixture is degassed by vacuum at 1-10 Torr for at least 2 h.

In certain embodiments, the hardening agent is mixed and stirred with the homogeneous epoxy resin-fly ash carbon nanotube mixture at a hardening agent/homogeneous epoxy resin-fly ash carbon nanotube mixture volume ratio of 1-5:10.

In at least one embodiment, the hardening agent is in liquid form and is amine-based or acid anhydride-based.

In one embodiment, the homogeneous epoxy resin-fly ash carbon nanotube mixture is cured and dried for 12-48 h at 45-55° C.

In certain embodiments, the epoxy-fly ash carbon nanotube polymer composite formed has a fly ash carbon nanotube content of 0.1 to 5.0% by weight per total weight of the polymer composite.

In one or more embodiments, the epoxy-fly ash carbon nanotube polymer composite formed has a lap shear strength of 250-1500 N, a tensile strength of 5-30 MPa, a Young's modulus of 0.1-0.5 GPa and an elongation at break of 20-100%.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a flowchart illustrating a method for preparing an epoxy composite according to one embodiment.

FIG. 2A is a scanning electron microscope (SEM) image of the as-grown carbon nanotube (CNT) clusters at 5,000× magnification.

FIG. 2B is a high resolution SEM image of the as-grown CNTs clusters of FIG. 1A, at 100,000× magnification.

FIG. 2C is a SEM image of CNT clusters dispersed in an epoxy matrix, at 5,000× magnification.

FIG. 3A is a transmission electron microscope (TEM) image of the as-grown carbon nanotube (CNT) clusters.

FIG. 3B is a high resolution TEM image of the as-grown CNTs of FIG. 2A, showing the formation of multi-walled CNTs.

FIG. 4 is a micro-Raman spectrum for the exemplary CNTs of the present disclosure, particularly indicating a high degree of wall graphitization (I_{G}/I_{D}˜1.5).

FIG. 5 shows multiple stress-strain curves of neat epoxy and epoxy-CNT composites having different CNT weight fractions.

FIG. 6 shows elongation-at-break values as a function of CNT weight fractions in epoxy-CNT composites.

### DETAILED DESCRIPTION OF THE EMBODIMENTS

Referring now to the drawings, wherein like reference numerals designate identical or corresponding parts throughout the several views.

As known in the art, an epoxy material is the cured end product of epoxy resins, also known as polyepoxides, which are a class of reactive pre-polymers which contain epoxide groups. Epoxy resins may be cross-linked or cured, by internally generated heat, either with themselves through catalytic homopolymerization, or with a wide range of co-reactants that are known hardeners or curatives. Examples of hardening agents include but are not limited to polyfunctional amines, acids, acid anhydrides, phenols, alcohols and thiols. The curing of an epoxy resin, which is an exothermic reaction, forms a thermosetting polymer having a wide range of industrial applications. Non-reinforced epoxies usually find applications in paint and metal coatings, structural and engineering adhesives used in construction of transportation vehicles, and microencapsulation. Fiber-reinforced epoxies are heavily used in the electronics industry as integrated circuit boards, transistors electronic and electrical components, light-emitting diodes (LEDs) and high tension electrical insulators, and in the thermoplastics industry.

The method of making an epoxy polymeric composite material of the present disclosure is a method in which carbon nanotubes of fly ash are homogeneously dispersed within the matrix of an epoxy resin. Through this method, an epoxy composite having rubber-like characteristics such as flexibility and elasticity, in addition to resistance to mechanical abrasion and chemicals, is produced.

As used herein, the term “fly ash” or “flue ash” refers to a waste residue generated in combustion of burned heavy fuel oil, for example, in power generation plants and desalination. Fly ash comprises fine ash particles that rise together with flue gases. Fly ash generated in combustion of burned heavy fuel oil has a carbon content of at least 80% by weight, which is generally higher than the carbon content of fly ash generated in combustion of coal. The carbon content of the fly ash used in the present disclosure is preferably 80-85%, 85-90%, more preferably 90-95% 95-98%, 95-99%, with the rest of the components being primarily metals or semimetals such as but not limited aluminum, magnesium, calcium, vanadium, nickel, copper, zinc chromium, cobalt, lead, manganese, mercury, molybdenum, selenium, strontium, thallium, arsenic, beryllium, boron, cadmium, as well as silicon and/or silica, sulfur, oxygen, organic compounds including but not limited to dioxins or polychlorinated dibenzodioxins (PCDDs) and polyaromatic hydrocarbons (PAHs). In one embodiment, the fly ash used to prepare carbon nanotubes has a carbon content 84.3% by weight, with the remainder of the fly ash largely being oxides of silicon, aluminum, nickel, vanadium and iron.

As used herein, the term “carbon nanotubes” or its acronym “CNTs” refers to allotropes of carbon having an elongated tubular or cylindrical structure or bodies which is typically only a few atoms in circumference. Carbon nanotubes are hollow and typically have a linear fullerene structure and one or more inner walls. Carbon nanotubes may be single-walled nanotubes (SWNTs), multi-walled nanotubes (MWNTs) or double-walled nanotubes (DWNTs). The carbon nanotubes of fly ash according to the present disclosure are multi-walled nanotubes where the number of walls ranges from 5 to 15, preferably from 7 to 12, more preferably from 8 to 10. Each wall has a thickness of 0.15-0.45 nm, preferably 0.2-0.4 nm, more preferably 0.25-0.35 nm, thereby leading to the nanotube having an outer diameter of 0.5-10 nm, preferably 1.0-7.5 nm, more preferably 2.5-5.0 nm. The length of the fly ash carbon nanotube is 0.1-100 μm, preferably 0.5-50 μm, more preferably 1-20 μm. In one embodiment, the carbon nanotubes have an outer diameter of 3.1 nm (with 10 walls) and a length of 1-10 μm, thereby resulting in a length-to-diameter ratio of 322 to 3225.

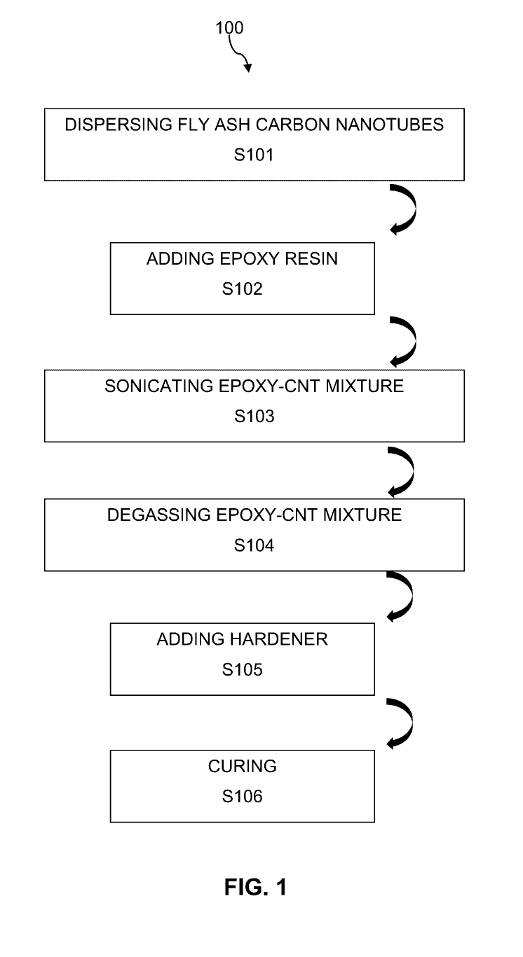

In FIG. 1, a flowchart of an epoxy-carbon nanotube composite preparation method according to one embodiment is presented. The method 100 begins with step S101 where carbon nanotubes of fly ash are dispersed in a minimum amount of a non-aqueous, organic solvent and mechanically stirred for 30-75 min to form a carbon nanotube dispersion. Examples of the organic solvent include but are not limited to methanol, ethanol, isopropanol, n-propanol, n-butanol, acetone, benzene, toluene, hexane, diethyl ether, dichloromethane, dimethylformamide, dimethylacetamide, acetonitrile, tetrahydrofuran, ethyl acetate, nitromethane, propylene carbonate and dimethyl sulfoxide. Preferably, the organic solvent is polar and may be protic or aprotic, and is selected from methanol, ethanol, isopropanol, n-propanol, n-butanol, acetone, dimethylformamide, dimethylacetamide, acetonitrile, tetrahydrofuran, ethyl acetate, nitromethane, propylene carbonate and dimethyl sulfoxide. More preferably, the solvent is ethanol or acetone. In one embodiment, ethanol is used as a solvent for dispersion of the fly ash carbon nanotubes. To the non-aqueous solvent, the carbon nanotubes of fly ash are added to a concentration of 20-250 g/L (g of carbon nanotubes of per liter of solvent), preferably 50-200 g/L, more preferably 75-150 g/L even more preferably 100-125 g/L.

In certain embodiments, the non-aqueous solvent in which the carbon nanotubes are dispersed contains one or more epoxy plasticizers. Epoxy plasticizers are epoxy additives that have heat-stabilizing effect, with examples thereof including but are not limited to hydrocarbon processing oil, phosphate esters (e.g., triphenyl phosphate, resorcinol bis(diphenyl phosphate), or oligomeric phosphate), long chain fatty acid esters, aromatic sulfonamide, poly(ethylene vinyl alcohol), cellulose acetate, polybutene, polyisobutylene, acetyl triethyl citrate, tributyl citrate, triethyl citrate, tri-(2-ethylhexyl) phosphate, triphenyl phosphate, dimethyl phthalate, diethyl phthalate, di-(2-ethylhexyl) phthalate, dimethyl sebacate, dioctyl sebacate, polyalkylene glycol, polyethylene glycol, polypropylene glycol, sulfolane (2,3,4,5-tetrahydrothiophene-1,1-dioxane), toluenesulfonamide derivatives and triacetin. The one or more plasticizers are added to the epoxy-carbon nanotube mixture so that the final epoxy-carbon nanotube composite product contains 0.5-20% of the plasticizer(s) by weight per total weight of the composite, preferably 0.5-15%, more preferably 1.0-10%, even more preferably 1.5-5.0%. Preferred plasticizers include dibutyl phthalate, di-n-decyl phthalate, poly(propylene glycol alkylphenyl ether), isodecyl pelargonate, cyclohexyl pyrrolidone, dioctyl phthalate, and/or di-n-decyl phthalate, which may be added to reduce hardness and improve elastic properties.

At step S102, an epoxy resin is added to the dispersion to form an epoxy-carbon nanotube mixture. The mixture contains the epoxy resin and carbon nanotubes at a resin/nanotube weight ratio of 10-1000:1, preferably 15-500:1, more preferably 15-20:1, 30-35:1, 65-500:1, most preferably 65-70:1, 125-135:1 and 490-500:1. The epoxy-carbon nanotube mixture is then ultrasonicated, at step S103, for 3-6 h, preferably 4-5 h to obtain a homogeneous mixture. The sonication power ranges from 50-150 W, preferably 75-125 W, more preferably 100-100 W, while the frequency ranges from 30-60 kHz, preferably 40-50 kHz, more preferably 40-45 kHz. In one embodiment, the output power of the sonicator was 100 W and the frequency was 42 kHz. In at least one embodiment, the sonification further removes at least a portion of the organic solvent, preferably 5-100% by mass per total mass of the organic solvent in the epoxy-carbon nanotube mixture, preferably 10-90%, more preferably 15-80%, 25-50%, or 30-40%. Next, at step S104, the epoxy-carbon nanotube mixture is degassed where dissolved gases such as but not limited to oxygen, carbon dioxide and nitrogen, are removed. After sonification and degassing most of the solvent may be removed but for an amount of a plasticizer. In one embodiment, the degasification is achieved by placing the mixture under vacuum (pressure=1-10 Torr) for at least 2 h, preferably 3-5 h. The method proceeds to step S105 where a hardening or curing agent is added to the epoxy-carbon nanotube mixture (now free of dissolved gases and optionally solvent, but optionally containing an amount of one or more plasticizers) at an agent/mixture volume ratio of 1-5:10, preferably 1-3:5, more preferably 1-2:5, then mechanically stirred at ambient temperature for 5-10 min to mix well. A suitable curing agent for the curing process in accordance with the present disclosure is in liquid form, and is either amine- or acid anhydride-based, with a non-limiting list of examples including diethylenetramine (DTA), tritethylenetetramine (TTA), tetraethylenepentamine (TEPA), dipropenediamine (DPDA), diethylaminpropylamine (DEAPA), N-aminoethylpiperazine (N-AEP), menthane diamine (MDA), isophoronediamine (IPDA), m-xylenediamine (m-XDA), methyltetrahydrophthalic anhydride, methylendomethylene tetrahydrophthalic anhydride, methylbutenyl tetrahydrophthalic anhydride, dodecenyl succinic anhydride, hexahydrophthalic anhydride and hexahydro-4-methylphthalic anhydride. After the addition of the curing agent, at step S106, the epoxy-carbon nanotube mixture is placed inside a mold and left to cure for 12-48 h, preferably 18-36 h, more preferably 20-28 h, at 45-55° C. In one embodiment, the epoxy-carbon nanotube mixture is cured for 24 h at 50° C.

At the end of the process 100, the epoxy-carbon nanotube composite produced is made up of an epoxy resin with carbon nanotubes of fly ash that are homogeneously incorporated and dispersed across the matrix. The amount of fly ash carbon nanotubes distributed in the epoxy resin matrix ranges from 0.1 to 5.0% by weight per total weight of the composite, preferably 0.15-3.0%, more preferably 0.2-2.0%, most preferably 0.25-1.0%.

Shear strength, in regards to epoxies, are common values used to portray the strength of epoxy. The most common of the shear strength values is lap shear strength. Lap shear strength is tested using ASTM D1002 Standard Test Method for Apparent Shear Strength of Single-Lap-Joint Adhesively Bonded Metal Specimens by Tension Loading (Metal-to-Metal), which is incorporated herein by reference in its entirety. This test method calls for a single lap joint bonded with an adhesive on standardized aluminum and allows for the lap shear strength of an epoxy standardized to aluminum. As measured with the ASTM D1002 method, the epoxy-carbon nanotube composite of the present disclosure has a lap shear strength of 250-1500 N, preferably 400-1250 N, more preferably 500-1000 N, even more preferably 600-750 N. Comparatively, a neat epoxy prepared in the same manner without the fly ash carbon nanotubes has a lap shear strength of approximately 2000 N. Generally, the shear strength decreases as the amount of fly ash carbon nanotubes in the epoxy composite increases.

Tension tests performed on the epoxy-carbon nanotube composite are in accordance with at least one of the following ASTM methods: the ASTM D412 Standard Test Methods for Vulcanized Rubber and Thermoplastic Elastomers-Tension, the ASTM D638 Standard Test Method for Tensile Properties of Plastics, the ASTM D1456 Standard Test Method for Rubber Property—Elongation at Specific Stress and the ASTM Standard Test Method for Young's Modulus, tangent Modulus, and Chord Modulus, all of which are incorporated herein by reference in their entireties.

As used herein, the terms “ultimate tensile strength”, “tensile strength” and “ultimate strength” refer to the maximum stress that a material can withstand while being stretched or pulled before failing or breaking. As measured, the epoxy-carbon nanotube composite of the present disclosure has a tensile strength of 5-30 MPa, preferably 10-25 MPa, more preferably 12-20 MPa. In comparison, a neat epoxy has a tensile strength of 40-50 MPa. Like shear strength, as the amount of fly ash carbon nanotubes increases in an epoxy composite, the tensile strength decreases.

As used herein, the terms “tensile modulus”, “Young's modulus” and “elastic modulus” refer to a measure of the stiffness of an elastic material defined as the ratio of the stress (force per nit area) along an axis to the strain (ratio of deformation over initial length). The measured Young's modulus of the epoxy-carbon nanotube composite is 0.1-0.5 GPa, preferably 0.2-0.4 GPa, more preferably 0.3-0.4 GPa. A neat epoxy, on the other hand, displays a Young Modulus of 1.0-1.2 GPa. It is therefore apparent that the presence of the carbon nanotubes reduces the stiffness of the epoxy.

As used herein, the term “elongation at break” refers to the maximum strain that can be placed on a material before it breaks or ruptures. The epoxy-carbon nanotube composite has a measured elongation at break of 20-100%, preferably 30-80%, more preferably 40-75%. In general, as the amount of carbon nanotubes incorporated in the epoxy resin increases, the elongation at break value of the composite increases. A neat epoxy, comparatively, has an elongation at break of no higher than 10%. The fly ash carbon nanotubes are effective in increasing the elongation at break of the epoxy by up to 15 times, preferably 5-15 times, more preferably 8-12 times.

In light of the above measured shear strength and tensile strength values, it is apparent that the epoxy-carbon nanotube composite of the present disclosure exhibits physical properties that are not commonly associated with epoxies. In addition to mechanical abrasion, high temperature and chemical resistance, the composite provided herein also exhibits rubber-like viscoelasticity and flexibility, and is hence well-suited as raw materials for manufacturing of a variety of items such as but not limited to vehicle tires, conveyor belts, hoses and rollers.

The present disclosure is not limited by the synthesis route of the fly ash carbon nanotubes. Accordingly, these nanotubes used for the making of the epoxy composite may be synthesized using any conventional technique including but not limited to arc discharge, laser ablation, high-pressure carbon monoxide disproportionation, chemical vapor deposition (CVD), low-pressure chemical vapor deposition (LPCVD) and high-pressure chemical vapor deposition (HPCVD). In a preferred embodiment, the carbon nanotubes of fly ash are synthesized by a LPCVD technique as described in U.S. Pat. No. 8,609,189 which is incorporated herein by reference in its entirety, where a fly ash sample is initially ultrasonicated for 4-8 h to produce an ultrafine powdered ash which is separated and dried. Then, the ultrafine powdered ash is placed inside a CVD reactor and depressurized at 10⁻³-10⁻⁴ Torr, then heated to a maximum of 600-900° C., preferably 650-750° C. at a heating rate of 15° C.-25° C./min. When the maximum temperature is reached, the carbon nanotubes are left to grow in the reactor for 20-35 min at 10-25 Torr. In one embodiment, a mixture of nitrogen and acetylene were introduced at flow rates of 200-250 sccm and 50-75 sccm, respectively. Acetylene gas is used as a co-precursor for CNT growth, along with nitrogen as a carrier gas. It should be understood that the nitrogen may be substituted with argon, which is also an inert gas and that other hydrocarbon gases can be used as co-precursors, such as ethane (C₂H₆) or methane (CH₄).

In the above, the treatment of the fly ash by ultrasound waves is used to break down large solidified fly ash particles and to enrich sp² hybridized carbons. It is known that ultrasound waves can transform graphite into diamonds by means of sp²-hybridized carbons being transformed into sp³. Additionally, some sp³ carbons may be converted into sp² carbons, which are required for carbon nanotube (CNT) growth. Further, it is also known that incomplete combustion of carbon-rich materials leaves products that still contain hydrocarbon compounds. These hydrocarbons could also decompose easily inside a tube furnace and provide sp²-hybridized carbons.

The carbon nanotubes of fly ash of the present disclosure have a purity of 95% or higher by weight of carbon per total weight of the carbon nanotubes, preferably ≧98%, more preferably ≧99%, with an ash content of less than 1.5 wt. %, preferably less than 1.0%, more preferably less than 0.75 wt. %. The specific surface area of the carbon nanotubes is at least 200 m²/g, preferably 200-750 m²/g, more preferably 250-500 m²/g. The electrical conductivity of the carbon nanotubes is at least 10² s/cm, preferably 10²-10⁵ s/cm, more preferably 10³-10⁴ s/cm.

As analyzed by Raman spectroscopy and Fourier transform infrared spectroscopy (FTIR), the multi-walled fly ash carbon nanotubes used to make the epoxy-carbon nanotube composites of the present disclosure display a high degree of wall graphitization (I_{G}/I_{D}=1.2-1.8, preferably 1.3-1.6) and C═C double bonds stretching at 1600-1650 cm⁻¹, respectively.

The fly ash carbon nanotubes of the present disclosure are shown, through scanning and/or transmission electron microscopy, to have a unique “hairy” morphology, where a core carbon nanotube is surrounded by a hair-like corona of fine, flexible carbon fibrous strands.

The present disclosure is further illustrated by the following examples of synthesis and characterization procedures and results of fly ash carbon nanotubes, epoxy and epoxy-carbon nanotube composites. It is noted that these examples are appended herewith strictly for illustrative purposes, and are not intended to limit the scope of the invention.

### Example 1

### Synthesis of Carbon Nanotubes (CNTs)

The CNTs were synthesized using a low-pressure chemical vapor deposition (LPCVD) technique, from carbon-rich fly ash of burned heavy oil sourced from desalination plants and power plants, as described in U.S. Pat. No. 8,609,189, which is incorporated herein by reference in its entirety.

Chemical analysis on the fly ash indicated that the fly ash was 84.3% pure carbon, with the remainder of the fly ash largely being oxides of silicon, aluminum, nickel, vanadium and iron. The CNT synthesis began with a fly ash sample that was ultrasonically treated to produce an ultrafine powdered ash. The output power of the sonicator was 100 W and the frequency was 42 kHz. It should be understood that any suitable type of sonicator may be utilized. Following sonication, the fine suspended particles were separated and dried at a temperature of approximately 70° C. Then, 2 g of the dried, ultrafine powdered ash was placed on a quartz boat and placed inside the quartz reactor tube of reacted in LPCVD reactor to form the CNTs. The reactor tube was depressurized to a pressure of approximately 10⁻³ Torr, and then heated to a maximum temperature of 700° C. at a rate of approximately 20° C./min.

When the temperature within the reactor tube reached the maximum temperature of 700° C., a mixture of nitrogen and acetylene gases were introduced with flow rates of 200 standard cubic centimeters per minute (sccm) and 50 sccm, respectively. Growth time in the reactor was kept fixed at approximately 20 min, and the chamber pressure was maintained at approximately 15 Torr.

### Example 2

### Synthesis of Epoxy-CNT Composites

Synthesis of the epoxy-CNT nanocomposite material was accomplished by initially dispersing, in ethanol, the obtained CNTs of fly ash using a magnetic stirrer for 1 h and then epoxy resin (from Fosam Company, KSA) was added to this solution. The CNTs/epoxy mixture in ethanol was ultrasonicated for 4 h to obtain a homogeneous dispersion. As in Example 1, the output power of the sonicator was 100 W and the frequency was 42 kHz. Then, the ethanol solvent was removed in a low-power ultrasonic bath. The solution was placed in the bath for about 4 h. Finally; the solution was kept at vacuum for 4 h under a pressure of 5 Torr to remove air bubbles. Four epoxy-CNT nanocomposite samples were prepared at different CNT concentrations: 0, 0.2, 0.75, 1.5, 3 and 5 percent by weight per total weight of the epoxy-CNT nanocomposite.

The formed CNT/epoxy dispersion was mixed with a hardener agent according to a mixing ratio of 10:3, and then mechanically stirred for 10 min. Then, the dispersion was placed inside a Teflon mold. The mold was cleaned prior to the placement to remove any dust, and then painted by a mold release agent to facilitate removing the sample from the mold after drying. The cured materials were kept for 24 h at 50° C. in an oven to remove any solvent residuals. Five specimens for each concentration were prepared. The neat resin was prepared using the same procedure used to prepare the nanocomposites (including the addition of ethanol).

### Example 3

### Characterization of Carbon Nanotubes and Epoxy-CNT Composite

The morphologies of the resulted CNTs and epoxy-CNT composite resins were analyzed by SEM using a FEI's Magellan 400 XHR-SEM, and TEM using FEI's Titan 80-300 TEM. A Raman spectrum was measured using a DXR Raman Microscope (Thermo Scientific) using the 532 nm laser as excitation source at a power of 8 mW.

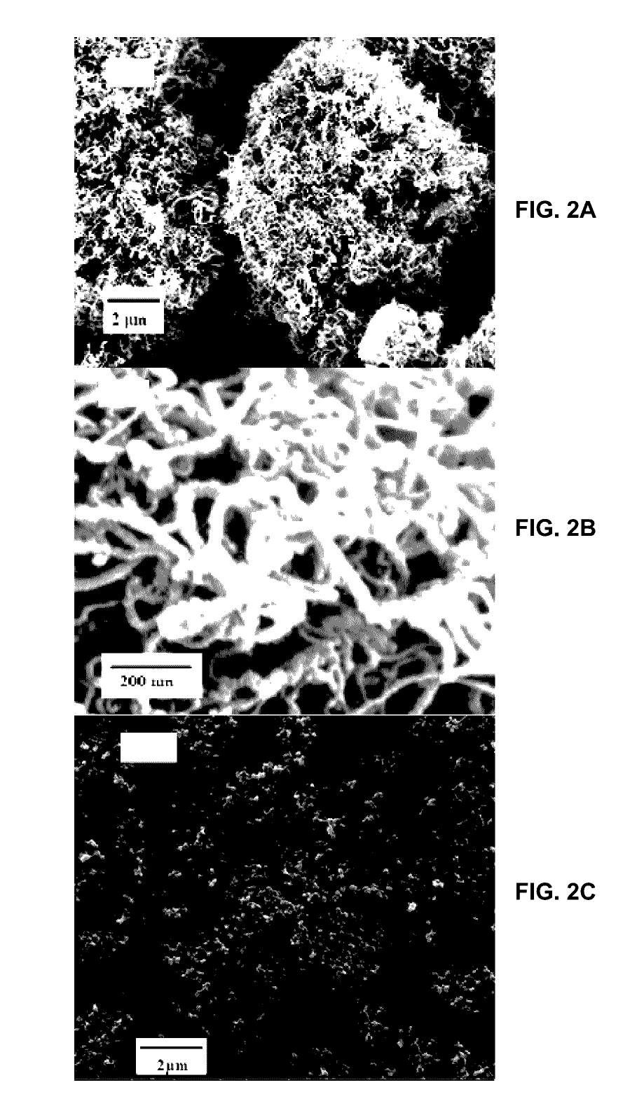

FIGS. 2A and 2B show SEM images at different magnification for the as-grown CNTs of fly ash. These CNTs have diameters and lengths in the ranges of 20-30 nm and 500-2000 nm, respectively, which agreed well with previously reported values [U.S. Pat. No. 8,609,189—incorporated herein by reference in its entirety]. An SEM image for the as dispersed nanotubes in the matrix of epoxy resin is shown in FIG. 2C, where the CNTs of fly ash can be clearly seen to be homogenously distributed in the matrix of the epoxy resin.

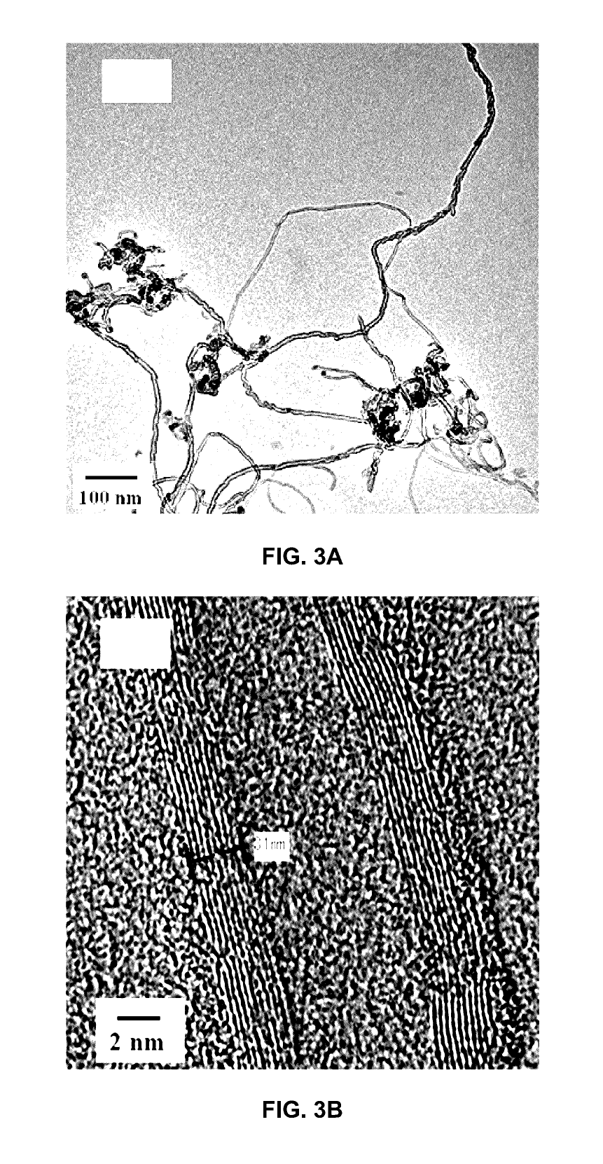

FIG. 3A shows a TEM image for the as-grown CNTs of fly ash. Well-defined nanotubes can be observed along with small catalyst particles. A high resolution TEM image is given in FIG. 2B, which clearly shows that these nanotubes are multi-walled (MWCNT). FIG. 3B shows each CNT having 10 inner and outer walls. The thickness of each wall is around 0.31 nm, which agreed well with the previously reported value [U.S. Pat. No. 8,609,189—incorporated herein by reference in its entirety].

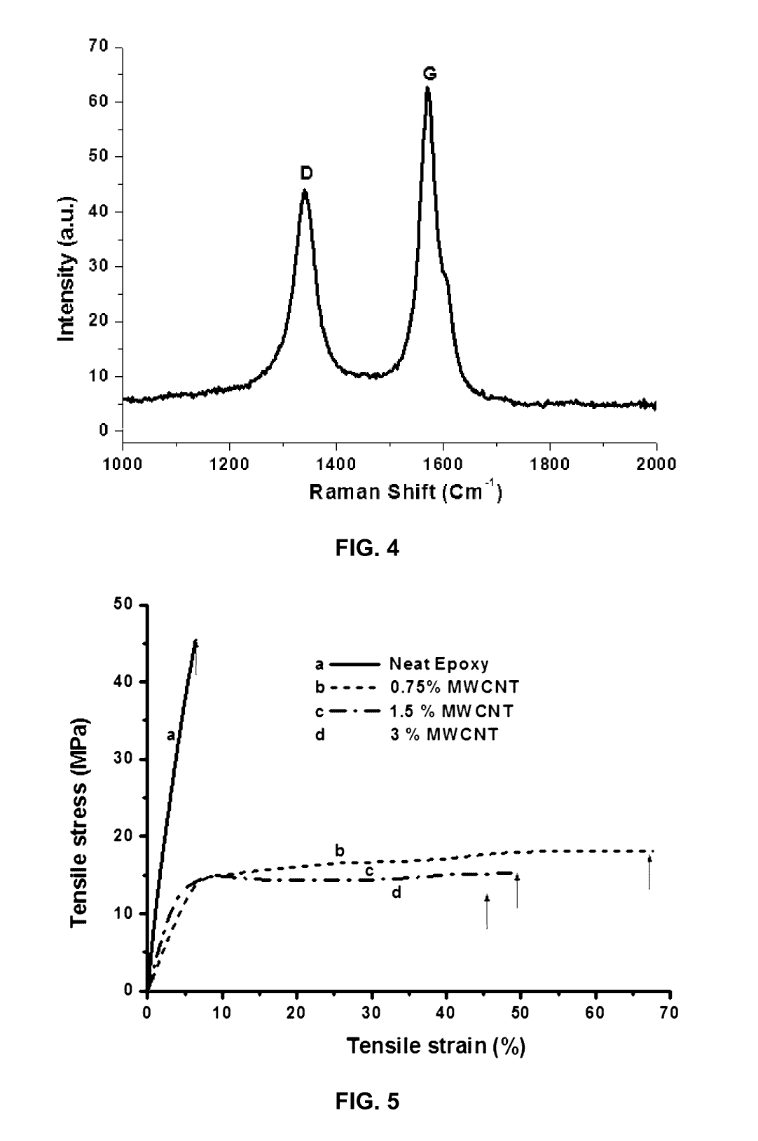

The as-grown CNTs of fly ash were also studied by Raman spectroscopy. Raman spectrum presented in FIG. 4 shows two well sharp peaks. The first one is at around 1350 cm⁻¹, which is attributed to the carbon materials disorder-induced band (D-band) and the second one is at 1582 cm⁻¹ which resulted from in-plane vibrations of graphite (G band) [R. Saito, A. Gruneis, G. G. Samsonidze, V. W. Brar, G. Dresselhaus, and M. S. Dresselhaus, New Journal of Physics 51, 157.1 (2003); L. Bokobza, and J. Zhang, Express Polymer Letters 6, 601 (2012)—each incorporated herein by reference in its entirety]. Experimentally, the intensity ratio of the G and D bands (I_{G}/I_{D}) is often used as an indication of the level of defect density on a graphitic carbon sample [M. S. Dresselahus, G. R. Dresselahus, and A. Jorio, Physics Reports 409, 47 (2004); C. Vix-Guter, J. Dentzer, P. Delhaes, Journal of Physical Chemistry B 108, 19361 (2004)—each incorporated herein by reference in its entirety]. The value of I_{G}/I_{D} in the present CNTs is around 1.5, indicating a good degree of graphitization for the prepared nanotubes.

### Example 4

### Mechanical Properties of Epoxy-CNT Nanocomposites

The neat epoxy and epoxy-CNT composite samples were tested using a tensile testing machine (INSTRON 3369, of a maximum load of 50 KN) with a rate of 5 mm/min. The mechanical analysis was been performed to study the effect of CNTs of fly ash on the mechanical properties of epoxy matrix. The data given in Table 1 shows the average testing results of the nanocomposite samples.

FIG. 5 shows the stress-strain curves of pure epoxy (curve a) and nanocomposites containing epoxy and CNTs of fly ash (curves b, c and d). The obtained mechanical measurements are listed in Table 1. Each outcome is averaged from five testing results. As given in Table 1, the maximum load on pure epoxy specimen is 1911.2 N, while the tensile strength, the Young's Modulus and the elongation at break are 45.5 MPa, 1.05 GPa and 6.4%, respectively. These results on epoxy matrix used in this experiment are close to several results obtained in the literature [Kim Jin Ah, Seong Dong Gi, Kang Tae Jin, and Ryoun Youn Jae, Carbon 44, 1898 (2006); E. Lopes Paulo, Hattum Ferrie van, M. C. Pereira Celeste, J. R. O. Nóvoa Paulo, Forero Stefan, Hepp Felicitas, Pambaguian Laurent, Composite Structures 92, 1291 (2010)—each incorporated herein by reference in its entirety].

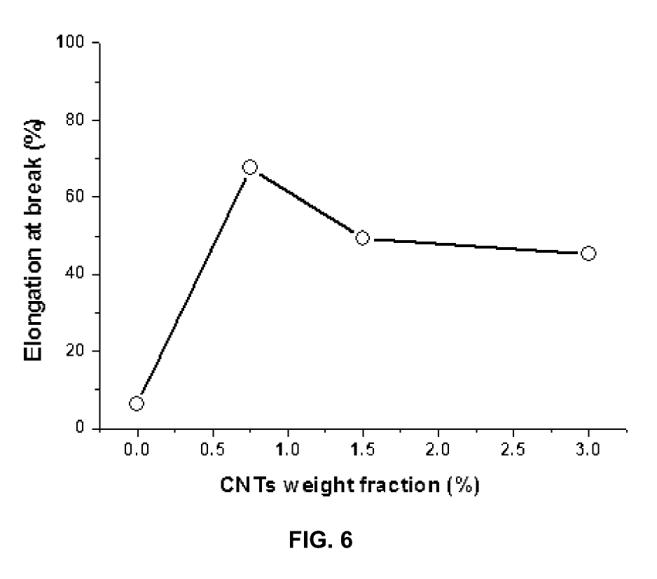

Stress-strain curves b, c and d for the CNT-reinforced epoxy composites are different from that of pure epoxy matrix (curve a) in that the maximum load on the three reinforced samples is less than 50% of that of pure epoxy. The stress-strain relations are almost linear only on short ranges, and do not exceed 15 MPa of stress and 5% of strain. The value of the resulting strength for the 0.75% CNTs reinforced epoxy was 17.4 MPa and it decreases with increasing the weight fraction of CNTs as shown in Table 1. The Young's modulus values for the reinforced samples also dropped to around 30% of that of pure epoxy matrix. These three values are more or less closer to each other. On the other hand, the values of elongation-at-break increase by a factor of around 8 times of that of pure epoxy matrix, particularly that of 0.75% CNTs, which shows the highest value, i.e. 67.6%. This can be seen in FIG. 6, which shows the obtained values of elongation at break as a function of CNT weight fraction. The highest value is obtained at 0.75 wt. % CNTs, while the other two values (i.e. for 1.5 wt. % and 3 wt. %) are around 70% of the former.

Conclusively, incorporation of CNTs of fly ash into a polymer host has produced a material having mechanical properties that more closely associated with rubbers rather than plastics. It is therefore suggested that the approach adopted by the present disclosure of incorporating CNTs of fly ash in an epoxy resin produces epoxy-CNT composites that are suitable as raw materials for items such as car tires and moving belts.

TABLE 1
Mechanical properties of neat epoxy and epoxy-CNT composites.

| | Max. | | Young's | Elongation |
|---|---|---|---|---|
| | Load | Strength | Modulus | at break |
| Sample | (N) | (MPa) | (GPa) | (%) |
| Neat epoxy | 1911.2 | 45.5 | 1.05 | 6.4 |
| Epoxy + 0.75 | 728.6 | 17.4 | 0.30 | 67.6 |
| wt. % CNT | | | | |
| Epoxy + 1.5 | 635.1 | 17.3 | 0.36 | 49.4 |
| wt. % CNT | | | | |
| Epoxy + 3.0 | 454.8 | 12.4 | 0.33 | 45.4 |
| wt. % CNT | | | | |

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1: A method for preparing an epoxy-fly ash carbon nanotube polymer composite, comprising:
dispersing fly ash carbon nanotubes in a non-aqueous solvent to form a fly ash carbon nanotube dispersion;
mixing an epoxy resin with the fly ash carbon nanotube dispersion to form an epoxy resin-fly ash carbon nanotube mixture;
sonicating the epoxy resin-fly ash carbon nanotube mixture to form a homogeneous epoxy resin-fly ash carbon nanotube mixture;
degassing the homogeneous epoxy resin-fly ash carbon nanotube mixture;
mixing a hardening agent with the homogeneous epoxy resin-fly ash carbon nanotube mixture; and
curing the epoxy resin-fly ash carbon nanotube mixture in a mold to form the epoxy-fly ash carbon nanotube polymer composite.

2: The method of claim 1, wherein the fly ash carbon nanotubes are derived from heavy fuel oil fly ash having a carbon content of 80% and higher.

3: The method of claim 1, wherein the fly ash carbon nanotubes are multi-walled and have an outer diameter of 0.5-10 nm.

4: The method of claim 1, wherein the fly ash carbon nanotube dispersion has a fly ash carbon nanotube concentration of 20-250 g/L.

5: The method of claim 1, wherein the organic solvent is polar and is at least one selected from the group consisting of methanol, ethanol, isopropanol, n-propanol, n-butanol, acetone, dimethylformamide, dimethylacetamide, acetonitrile, tetrahydrofuran, ethyl acetate, nitromethane, propylene carbonate and dimethyl sulfoxide.

6: The method of claim 1, wherein the epoxy resin-fly ash carbon nanotube mixture has an epoxy resin/fly ash carbon nanotube weight ratio of 10-1000:1.

7: The method of claim 1, wherein the epoxy resin-fly ash carbon nanotube mixture is sonicated at 80-120 W, 42-45 kHz for 3-6 h.

8: The method of claim 1, wherein the sonicating removes the organic solvent from the epoxy resin-fly ash carbon nanotube mixture.

9: The method of claim 1, wherein the homogeneous epoxy resin-fly ash carbon nanotube mixture is degassed by vacuum at 1-10 Torr for at least 2 h.

10: The method of claim 1, wherein the hardening agent is mixed with the homogeneous epoxy resin-fly ash carbon nanotube mixture at a hardening agent/homogeneous epoxy resin-fly ash carbon nanotube mixture volume ratio of 1-5:10.

11: The method of claim 1, wherein the hardening agent is in liquid form and is at least one of amine-based and acid anhydride-based.

12: The method of claim 1, wherein the homogeneous epoxy resin-fly ash carbon nanotube mixture is cured and dried for 12-48 h at 45-55° C.

13: The method of claim 1, wherein the epoxy-fly ash carbon nanotube polymer composite formed has a fly ash carbon nanotube content of 0.1 to 5.0% by weight per total weight of the polymer composite.

14: The method of claim 1, wherein the epoxy-fly ash carbon nanotube polymer composite formed has a lap shear strength of 250-1500 N.

15: The method of claim 1, wherein the epoxy-fly ash carbon nanotube polymer composite formed has a tensile strength of 5-30 MPa.

16: The method of claim 1, wherein the epoxy-fly ash carbon nanotube polymer composite formed has a Young's modulus of 0.1-0.5 GPa.

17: The method of claim 1, wherein the epoxy-fly ash carbon nanotube polymer composite formed has an elongation at break of 20-100%.
